(19) United States
(12) Patent Application Publication
(10) Pub. No.: US 2021/0362661 A1
(43) Pub. Date: Nov. 25, 2021

(54) Permanent Semi Truck and RV Reversing Camera Apparatus

(71) Applicant: George Edward Gorgees, Sterling Heights, MI (US)

(72) Inventor: George Edward Gorgees, Sterling Heights, MI (US)

(21) Appl. No.: 16/878,664

(22) Filed: May 20, 2020

(51) Int. Cl. B60R 11/04; H05B 47/105; H05B 45/10; F21V 15/01; G03B 15/03; B60R 16/03

(52) U.S. Cl. CPC B60R 11/04; H05B 47/105; H05B 45/10; F21Y 2115/10; G03B 15/03; B60R 16/03; F21V 15/01

(57) ABSTRACT

A permanent semi-truck and RV reversing camera apparatus is for assisting tractor trailer and towed RV drivers while backing up to a park space or freight doors. The apparatus house a camera body that includes a wide-angle lens which communicate with an embedded transmitter that streams live video to an app enabled personal electronic device. The apparatus also includes a light emitting diode (LED) projector that contain a physical toggle switch, on-off bases, to be selectively engaged when is needed while backing up at night. The apparatus operation and usage may depend on the hardwiring linkage of the camera and LED wires to the side marker light of the Semi-trailer or towed RV, to be supplied with direct current power (DC) circuit; the camera and LED positive wires may be merged at the marker light positive pole, and the negative wires will meet at the ground pole of the trailer marker light. A fiberglass sheet equipped with industrial glue is used to mount the apparatus: the front side of the sheet may stick firmly to the apparatus, while the back side of the sheet is used to mount it on the lower right corner of the semi-trailer or RV surface.

The invention is specially designed for semi-trucks/trailers, also known as 18 wheelers that use 5th wheel and is intended to fundamentally help the drivers while reversing angularly by viewing clearly the trailer's right end corner that is totally blind; the invention also would not interfere with opening or closing of the trailer door because it will be mounted on or near the taillight unit, far underneath the trailer door. Similarly, the invention is also specifically designed for long-towed RVs that use 5th wheel, gooseneck hitch, or other hitches that bends the two-piece combination vehicle angularly during a reverse. Thus, the invention is designed to eliminate the total blind spot located on the right-end and lower corner of the long-towed vehicles.

The invention must be filed to the US patent office specifically for long-towed combination vehicles, especially semi-tractor/trailers and long towed RVs; a combination vehicle that operate and use 5th wheel mechanism, gooseneck hitch or any other towing hooks. Although the invention may be used on a straight truck or other one-piece RV, however, it is not specifically designed and or to be patented for such vehicles.

### CROSS-REFERENCE TO RELATED TO APPLICATIONS

Not Applicable

### STATEMENT REGARDING FEDERALLY SPONSORED RESEARCH OR DEVELOPMENT

Not Applicable

### THE NAME OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURE BY THE INVENTOR OR JOINT INVENTOR

Not Applicable

### BACKGROUND OF THE INVENTION

### (1) Field of the Invention

The disclosure relates to long vehicle cameras and more particularly pertains to a new vehicle camera for assisting Semis, such as tractor-trailer while backing up to a loading/unloading docks or simply reversing the vehicle to designated truck park. Also, the assistance applies to RV towers in backing up to a designated parking space.

### (2) Description of Related Art Including Information Disclosed Under 37 CFR 1.97 and 1.98

The prior art relates to vehicle cameras, particularly for assisting drivers while backing up. Most existing backup cameras are designed for regular one-piece non-towing vehicles, which require a permanent installation in a central location of the rear of the vehicle. The hardwiring of such cameras is typically fixed to a viewing monitor placed within the dashboard or to some rearview mirror. However, large vehicles, specifically tractor-trailers and long towed RVs that use and operate a 5th wheel mechanism, a goose neck hitch connection or any other angular towing hitch are prone to sharp angle turning or bending during reverse. Usually all truck drivers of such combination vehicles would start a reverse by turning their towed trailers to the left side, both, tractor and trailer will be at a continual moving angle between 90 and 170 degrees toward the left; which is the only safe side that can be visually observed from driver seat. When reversing the semi-truck/trailer to whether fit it into a designated park space or backing it to a freight door or cock it will certainly have a complete blind spot on the rear-right side which it would require tedious observing and several on-foot physical checking and arduous maneuvering to avoid colliding with other parked trucks, structures or objects.

### BRIEF SUMMARY OF THE INVENTION

An embodiment of the disclosure meets the needs presented above by generally comprising an apparatus housing body that holds the coupled camera body and lens, as well the LED projector frame and guard. The camera lens frame would sit right on top of the apparatus body, a wireless or Wi-Fi transmitter is embedded within the camera to communicate and remotely transmit live videos to personal smart electronic devices. The LED projector light frame would sit on top of the camera frame, both parts of the apparatus, the camera and LED projector must and should have independent wiring system for two reasons; The first is to make it easy to replace the LED part or the camera part of the apparatus separately when either of them gets fried or malfunction. Second, the LED light would be designed to have a manual switch that allows to be shut off when is not in use, especially when the vehicle is driving in the streets at night. Comes with the apparatus an adhesive hard fiber sheet which sticks to the back of the apparatus body from its frontside and sticks to back of the trailer body or RV in backside. The fiber sheet is to firmly mount the apparatus at the right-lower corner of the trailer or RV. The apparatus can also be removed, detached wires from the marker light and place it on other trailer or RV by simply removing the fiber sheet and applying new one to another desired trailer or RV.

The more important features of the disclosure have been outlines broadly in detailed description that follows in order pattern and presented in a form of art that may be better understood and appreciated. There are additional features of the disclosure that will be described hereinafter which will form the subject matter of the claims appended hereto.

The objects of the disclosure, along with various features of novelty which characterize the disclosure, are pointed out with particularity in the claims subordinated to and forming part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the given drawings wherein:

FIG. 1 is an isometric view of a permanent or semi-permanent semi-truck and RV reversing camera apparatus, according to an embodiment of the disclosure.

FIG. 2 is a side elevation view of an embodiment of the disclosure, trailer's marker light, and a corner bracket.

FIG. 3 is an in-use view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

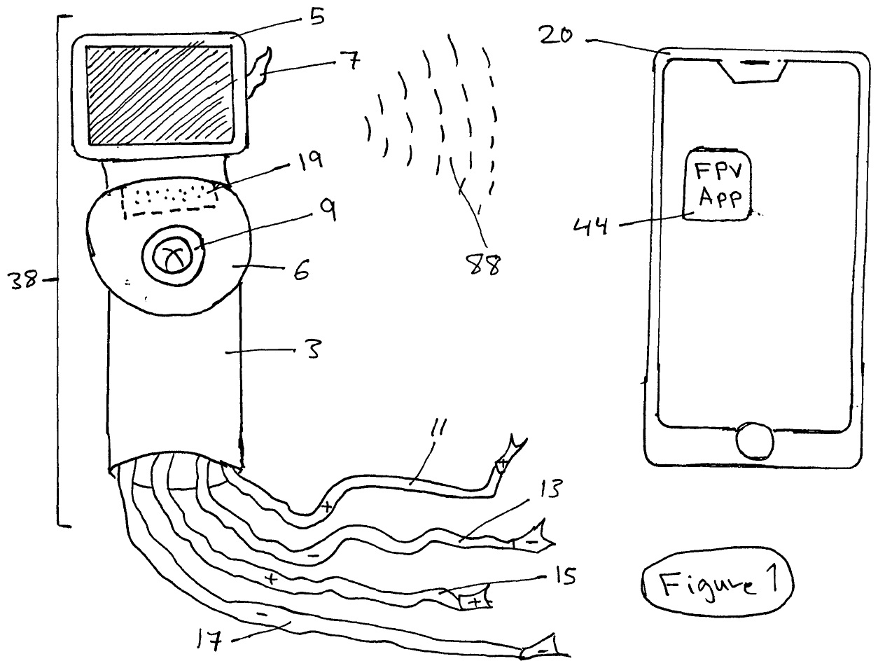

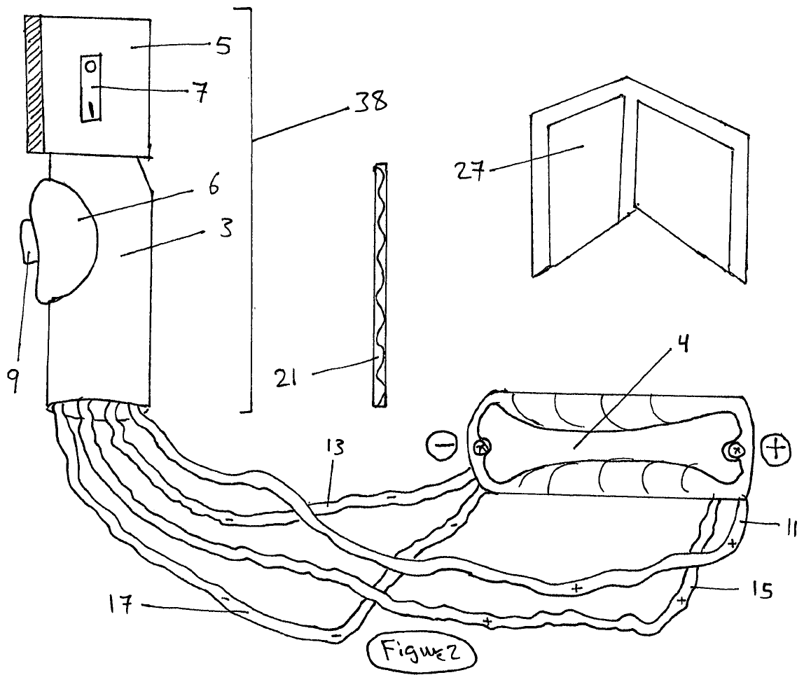

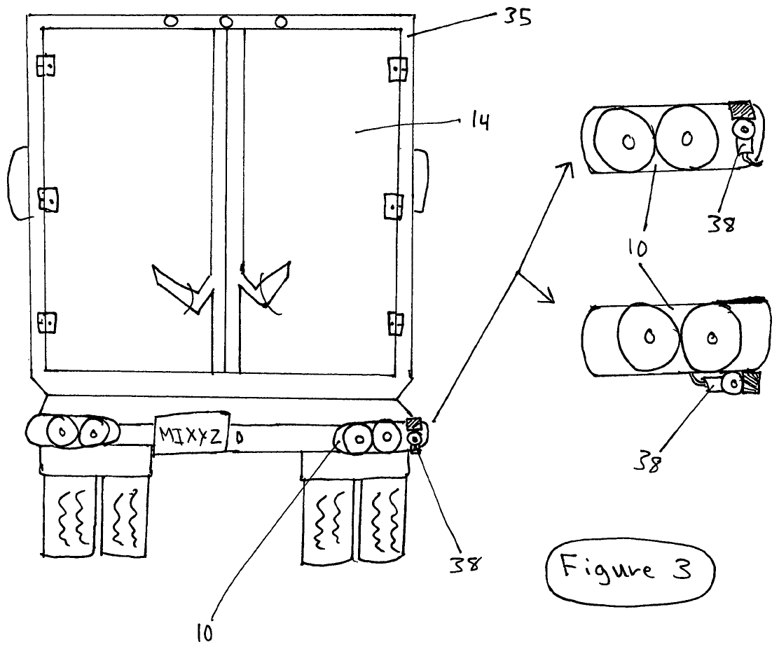

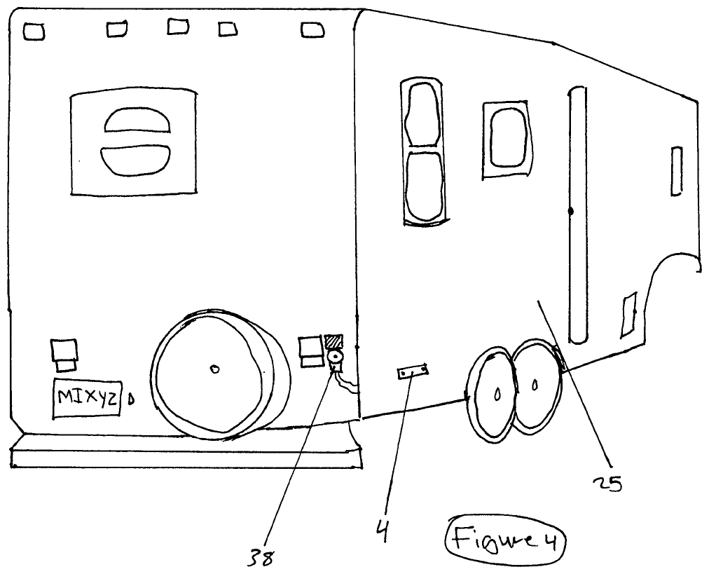

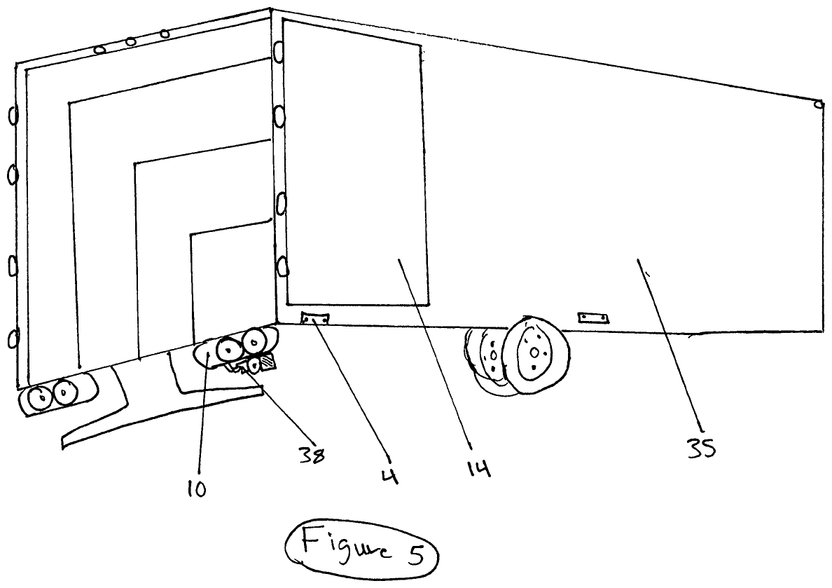

With reference now to the drawings, and in particular to FIGS. 1 through 6 thereof, a new vehicle camera embodying the principles and concepts of an embodiment of the disclosure and generally designated by numeral reference 38 will be described.

As it is best illustrated in FIGS. 1 through 6, The semi-truck and RV reversing camera apparatus 38 comprises a device housing body 3. The device housing body 3 shape may be curved like a cylinder to contain the wiring system of the apparatus and hold its parts together.

A camera body 6, a round-spherical shape and its round lens 9 is attached to the housing body 3 via a fastener bracket. The camera 6 may be watertight and generally weatherproof, the lens 9 may be fisheye to achieve wide viewing angle and may as well as having other smart capabilities like measuring the distance to the nearest object which communicates it via the transmitter 19 and the receiver 20. The measurement may be displayed in numeral form along with the live viewing video of the surroundings. A transmitter 19 is embedded with the camera body 6 and is in operational communication with the camera lens 9 to transmit live video to personal electronic device 20. The transmitter 19 may operate using Wi-Fi, Bluetooth, radio, or other wireless technology 88 to stream live videos to the personal electronic device 20. The personal electronic device 20 may utilize a propriety application: a first-person view (FPV App) 44 downloaded to the user's smart cellphone 20 or other smart tablets. Extending from camera body 6 is two power supply wires 11 and 13. A red color camera power wire (positive) 11 and black color ground wire (negative) 13. Both camera wires 11 and 13 may extend and pass through the hollow of the device housing body 3.

A square and cubical shape LED projector light 5 is coupled with the device housing body 3, mechanically fastened and attached generally on top of the camera body 6 if the device is mounted vertically or beside the camera body 6 if the apparatus is mounted horizontally. The LED light body may contain a protruding toggle switch (on-off) 7. Extending from the LED light 5 is two power supply wires 15 and 17. A red color LED projector power wire (positive) 15, and black color LED projector earth wire (negative) 17. Both LED light wires 15 and 17 may extend and pass through the hollow of the device housing body 3, along with but isolated from camera power supply wires 11 and 13. The trailer's lower right-side marker light 4 would supply power to operate the apparatus 38 by connecting the camera 6 power supply wires 11 and 13, along with LED projector 5 power supply wires 15 and 17 and merging them to complete a power DC circuit: positive (red) wires 11 and 15 of the apparatus 38 may be linked to the trailer 35 or RV 25 marker light's 4 positive pole and the negative (ground) wires 13 and 17 of the apparatus 38 may be linked with the negative (ground) pole of the semi-trailer's 35 or RV's 25 marker light 4. In short, positive wires to be linked with positive pole, and negative wires to be linked with negative pole of the marker light 4 to complete a direct current (DC) circuit for the purpose to supply power to the apparatus 38 to continually operate it and utilize it whenever is needed for backing up the vehicle.

A fiberglass sheet 21 that may have both sides equipped with industrial glue that may be used to mount the apparatus 38, one side is designated to sticks to the back of the apparatus body and the other side assigned to sticks to the body of long-towed RV's 25 lower right-side corner or on the semi-trailer 35 lower right side corner, most preferably on trailer's right side taillight unit 10, the size of the apparatus 38 may generally be small relatively to the space available in the lower-right corner of the semi-trailer 35, specially to allow the usage of the apparatus 38 even when the trailer door 14 is open and backing toward freight docks. Sometimes a corner bracket 27 may be used to mount the apparatus 38 appropriately to make it fit to all type of semi-trailers taillight unit 10 or any lower right-end corner space to be used. Also, the apparatus 38 may selectively be mounted horizontally under the taillight unit 10 of some semi-trailers that may have narrow taillight unit 10 space or may be based on some drivers' desire to be mounted in such position that might assist them better with the viewing of the surroundings. The apparatus 38 can be removed and placed on other desired semi-trailers 35 or long-towed RVs 25 by disassembling the wires 11, 13, 15, and 17 from the right-side marker light unit 4 power supply wires and detach the apparatus 38 from the fiberglass sheet 21. A new fiberglass sheet 21 may be used on another desired trailer 35 or RV 25.

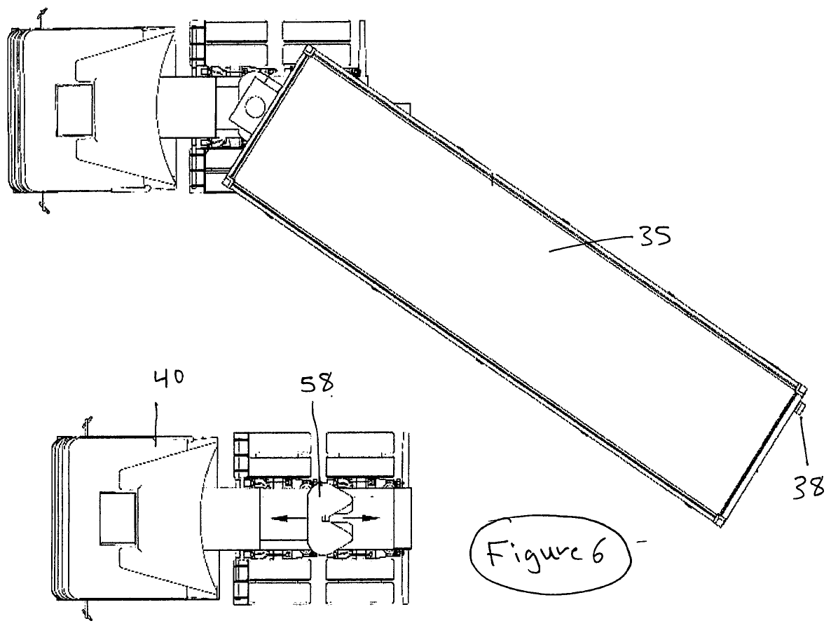

In use summery, the fiberglass sheet 21 may be installed on rear lower-right end of the semi-trailer 35, most desirably on the right taillight unit 10, under the trailer door 14 to allow the opening or closing of the trailer door 14 without obstruction, especially when reversing toward a warehouse freight docks or even a designated park space. A reverse is always at 90 degrees or more angle. The use and purpose of the apparatus 38 is to confidently view the surroundings of the trailer's right-end blind spot, to be directly displayed on the personal electronic smart device 20 from within the truck cab 40. Similar concept may be applied to long-towed RV 25; the apparatus 38 must be installed permanently on the lower right corner of the RV 25 to fully view the RV's right-end blind spot via smart electronic device 20 while backing up to a park space to avoid colliding with other parked vehicles or structures. The apparatus will confidently assist drivers of such long vehicles (RVs and Semi-Tucks) while reversing, which is always executed in angular shape toward the left as it is illustrated in FIG. 6.

With respect to the above description then, it is to be realized that the optimum dimensional relationships for the parts of an embodiment enabled by the disclosure, to include variations in size, material, shape, form, function, and manner of operation, assembly and use, are deemed readily apparent and obvious to one skilled in the art, and all equivalent relationships to those illustrated in the drawings and described in the specification are intended to be encompassed by an embodiment of the disclosure. Therefore, the foregoing is considered as illustrative only of the principles of the disclosure. Furthermore, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements. These principle might relates to an example given hereto, to not restrict the linkage of the apparatus to the trailer's side marker light; it can also be linked to the trailer or RV taillight's marker light, which it will provide same DC power supply and operation; this is a prime example that serves as an illustration of inclusion of many other possible options that might contribute to the operation and utilization of the invention.

Moreover, the main principles of this invention are specifically intended for long towed vehicles, primarily a combination vehicle: a semi-tractor/trailer that use 5th wheel mechanism, and long towed RVs that use a variety of towing hitches including 5th wheel and gooseneck hooks. These long vehicles are a perfect candidate to apply and use the principles of the invention, consequently, those principles would contribute greatly to the process of approval and development of this patent.

I claim:

1. A permanent semi-truck and RV reversing camera apparatus comprising:
A device housing body;
A camera body coupled to the housing body via fastening bracket or lock and key joint. The camera having a lens extending forward, front side of the housing body;
A transmitter is embedded within the camera body, the transmitter being in operational communication with the camera and configured to transmit live video to a personal electronic smart device;
A direct current (DC) power supply wires attached to the camera body, having a power-red wire (positive) and a ground-black (negative), both wires may be contained and extended through the cylindrical structure of the device housing body.
A light emitting diode (LED) is coupled with the camera body and the device housing body via lock and key joint or fastening brace, having a multiple column of lights covered with durable glass panel;
A direct current (DC) power supply wires attached to the LED projector, having a power-red wire (positive) and a ground-black (negative), both wires may be contained and extended through the cylindrical structure of the device housing body.
A toggle, protruding, and fully accessible on-off switch is embedded within the LED body structure, may control the flow of the current to light up the LED, only when needed during a reverse at night and to be turned off when the vehicle is driving through the roadways.
A mounting fiberglass sheet, two sides may be equipped with industrial ready to apply glue: one side is designated to stick firmly to the back of semi-trailer or RV body and the other side is dedicated to adhere and tightly hold in place the permanent semi-truck and RV reversing camera apparatus.

2. The permanent semi-truck and RV reversing camera apparatus of claim 1 further comprising of a smart camera lens or a laser focusing knob that may measures the distance between the lower right corner of the semi-trailer or RV and other parked vehicles or structures.

3. The permanent semi-truck and RV reversing camera apparatus of claim 1 further comprising of three main parts: a curved-cylindrical housing body, a round-spherical camera body, and a square-cubical LED projector light. May the edges of each part be covered with enduring industrial rubber guards which it may help to withstand potential physical impacts to protect the hardware of the apparatus.

4. The permanent semi-truck and RV reversing camera apparatus of claim 1 further comprising of weatherproof hardware parts, the camera, the LED body, and the wiring system of the apparatus may resist and be safeguarded against any water or heat damages as well as to endure all kind of weather corrosions.

5. The permanent semi-truck and RV reversing camera apparatus of claim 1 further comprising of two independently operational parts: the camera and the LED light; both parts may have independent wiring system, although the wires may be bundled and merged together at the marker light's positive and negative poles; the apparatus can also be hardwired or linked to the semi-trailer or RV taillight's marker light instead of trailer's side marker light, this way it will provide the same power supply and usage. Most importantly, the purpose of the separation of the apparatus's two parts (Camera and LED) wiring is to easily allow the replacement of either part when it potentially malfunctions or breaks down.

6. The permanent semi-truck and RV reversing camera apparatus patent may be firstly considered for combination vehicles such as, semi-truck/trailer and long towed RV that use and operate on 5th wheel, gooseneck, and other towing hooks to assist these drivers when reversing in angular path toward the left. Also, the apparatus can be used on other type of long vehicles, like straight trucks and busses, as a result, the application of the invention's principles would freely cover a broader scope of utilization in reversing large and long vehicles and it will maximize all the apparatus's potential capabilities.
